(19) United States
(12) Patent Application Publication
(10) Pub. No.: US 2006/0109960 A1
(43) Pub. Date: May 25, 2006

(54) System and method for unilateral verification of caller location information

(76) Inventors: Linda Kaye D'Evelyn, Lafayette, CO (US); George Heinrichs, Longmont, CO (US); Michael Arthur Koepke, Geneva, IL (US); Stephen Marc Meer, Niwot, CO (US); Raymond Eugene Paddock, Louisville, CO (US); Peter Roy Schmidt, Westminster, CO (US)

Correspondence Address: INTRADO INC., 1601 DRY CREEK DRIVE, LONGMONT, CO, 80503, US

(21) Appl. No.: 11/257,262

(22) Filed: Oct. 24, 2005

Related U.S. Application Data
(60) Provisional application No. 60/622,066, filed on Oct. 25, 2004.

(51) Int. Cl. H04M 11/04

(52) U.S. Cl. 379/37; 379/45

(57) ABSTRACT

A system and method for members of the public to retrieve and verify the accuracy of emergency response information that is associated with a communication device and would be utilized in an emergency services network should the device be used to summon emergency services. Such information can include location of the origin of a call for emergency services, identification of emergency service providers who would respond to such a call, and/or the level of accuracy of location information that would be provided to an emergency service dispatcher were such device used to summon emergency services.

### CROSS REFERENCE TO RELATED APPLICATIONS

This application claims the benefit of U.S. U.S. Provisional Patent Application No. 60/622,066, filed Oct. 25, 2004, entitled “SYSTEM AND METHOD FOR RETRIEVAL AND VERIFICATION OF EMERGENCY RESPONSE INFORMATION,” which is incorporated by reference herein in its entirety.

### BACKGROUND OF THE INVENTION

The present invention is directed to providing location information concerning a communication device, and, more specifically, to a system and method that provides location and other emergency response information associated with a communication device to the user of the communication device for informational, testing, and, importantly, verification purposes.

Modern technology provides a wide variety of devices with which one person may communication with another person, or, in fact, with several other people simultaneously. These communication devices include such diverse elements as hardwired landline telephones, wireless telephones, wireline data communication, wireless data communication and voice over data communications (VoIP). Each type of communication device is supported by one or more communications networks that provide the end-to-end connectivity to effects such communication.

Despite this diversity of technology, all of the various communications networks must be able to determine the location of each communications device that it supports and, advantageously, deliver other information that may aid in an emergency. Such location information is critical in the public safety or emergency services area. When a caller makes an emergency services call (“9-1-1” in the United States), all communications networks deliver the call to a “Public Safety Answering Point” (herein “PSAP”) that serves the emergency services jurisdiction (known in the art and referred to herein as “emergency service zone” or “ESZ”) wherein the communications device is located. The telephone number (TN) and location of the communications device within the ESZ is delivered to the emergency services operator taking the call. In some systems, other information, such as medical conditions, presence of hazardous materials, etc., is also delivered to the emergency services operator. Each communications technology has its own method for providing such information to the emergency services operator.

A major issue facing the communications industry, therefore, is not how to obtain location data of a communication device, but to insure the accuracy of the data. It does no one any good to dispatch emergency aid to the wrong location. Further, there are now standards as to the accuracy of the determined location of a mobile device. There is, however, no efficient manner in which to verify location and other data that is delivered to the emergency service operator.

### SUMMARY OF THE INVENTION

This problem is solved and a technical advance is achieved in the art by a system and method that provides direct public access to and verification of the location data of a calling communications device and, advantageously, any other information regarding the user or the environment of the communications device. Such verification is performed in a manner that is the same or similar to that which the communications network uses to insure that the information is as close as possible to that actually used in the communications network. In accordance with one exemplary embodiment of this invention, a mobile communication device receives a communication initialization signal. The communication device then receives data comprising location data of the communication device that initiated the communication. The data is then translated into human-understandable form and conveyed to the user of the communication device. The device may be a mobile telephone, personal digital assistant, two-way pager or any other similar mobile system. The human-understandable form may be text on a text display, graphics on a graphics display (such as a map) or audio information.

According to another exemplary embodiment, a communication device receives location data as part of the communication initialization signal. The device then translates the location data into human-understandable form and conveys that data to the user of the communication device. Examples of this system include personal computers (PC's), short message service systems, email systems and landline telephone.

### BRIEF DESCRIPTION OF THE DRAWINGS

A more complete understanding of this invention may be obtained from a consideration of this specification taken in conjunction with the drawings, in which:

FIG. 1 illustrates a generic exemplary embodiment of the invention set in the context of an emergency services network;

FIG. 2 illustrates a block diagram of an exemplary retrieval system of FIG. 1;

FIG. 3 illustrates an exemplary embodiment of this invention in the context of an emergency services network in which wireline technology is used;

FIG. 4 illustrates an exemplary call flow in the wireline network of FIG. 3 FIG. 5 illustrates an exemplary embodiment of this invention in the context of an emergency service network in which wireless technology is used;

FIG. 6 illustrates an exemplary call flow in the wireless network of FIG. 5;

FIG. 7 illustrates an exemplary embodiment of the invention set in the context of an emergency services network in which Voice over Internet Protocol (VoIP) technology is used;

FIGS. 8A and 8B illustrate exemplary call flows in the VoIP network of FIG. 7;

FIGS. 9A, 9B and 9C comprise a flow chart illustrating an exemplary embodiment of one aspect of the method of the invention, namely, an exemplary sequence for interactive voice response;

FIG. 10 is a flow chart illustrating an exemplary embodiment of the method of the invention;

FIG. 11 is a flow chart illustrating an exemplary embodiment of one step illustrated in FIG. 10; and

FIG. 12 is a flow chart illustrating an exemplary embodiment of another step illustrated in FIG. 10.

### DETAILED DESCRIPTION

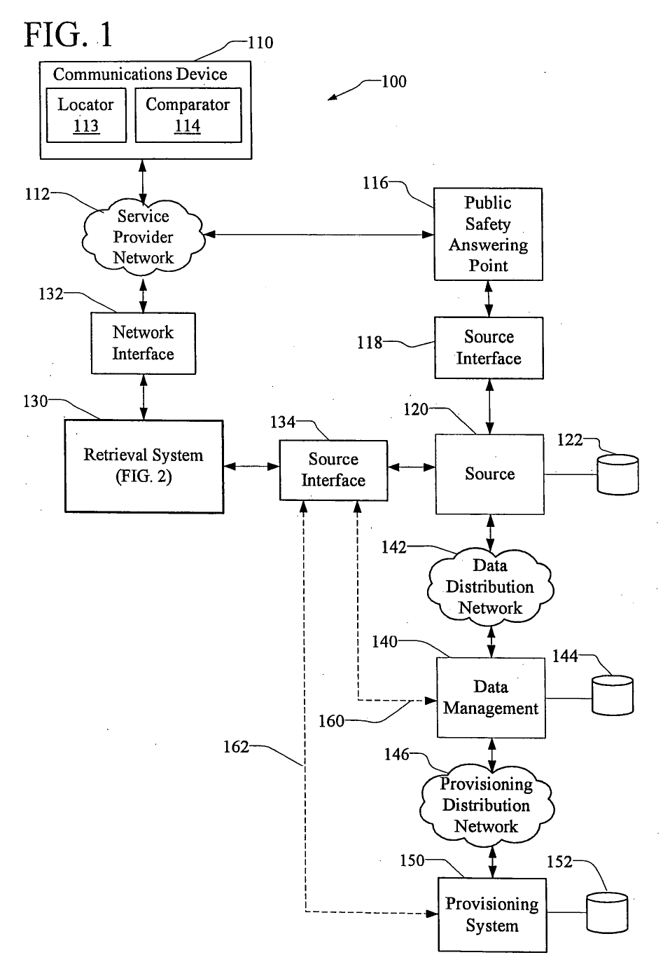

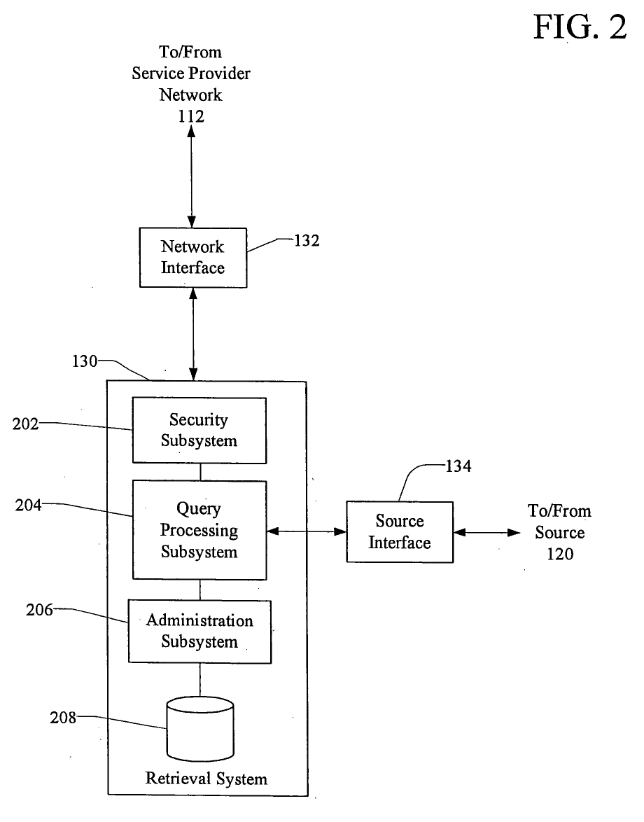

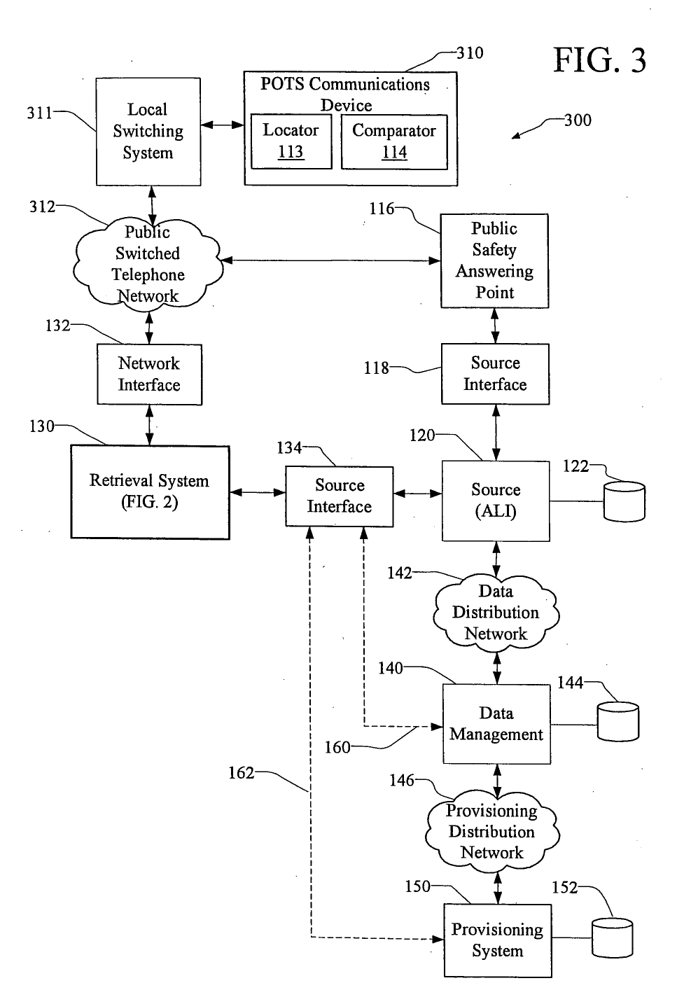

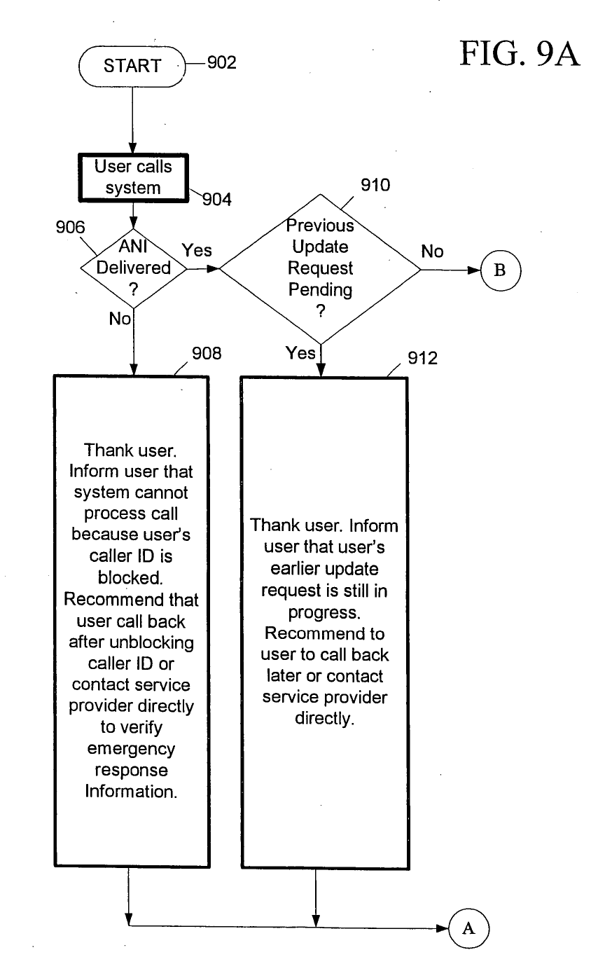

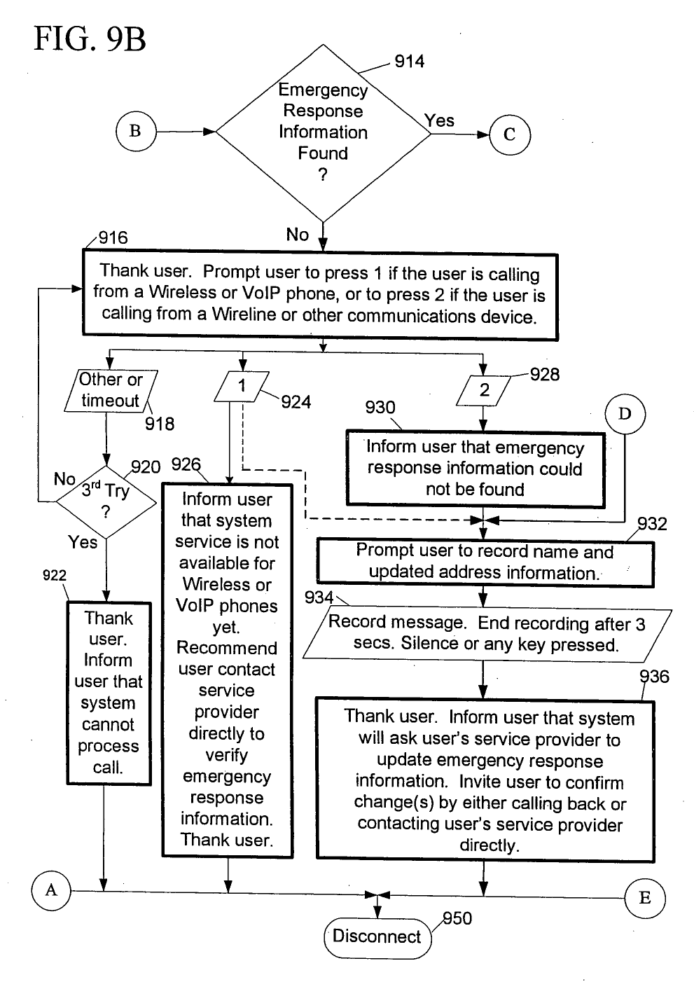

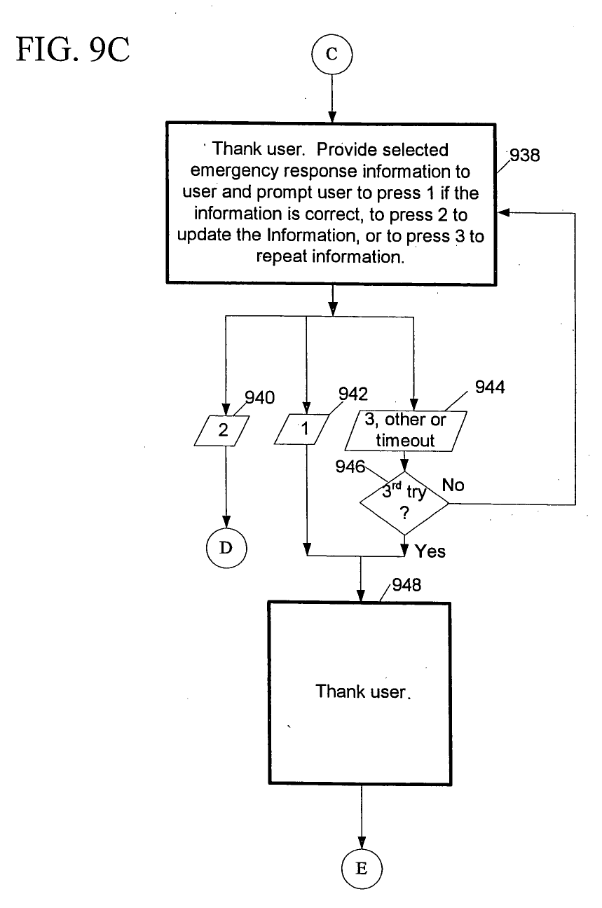

FIGS. 1-8 and the following description describe various embodiments of the present invention. In general, a system is provided to permit communications service provider personnel, consumers, or, advantageously, both to access subscriber information regarding the communication device that he or she is using, without interfering with emergency services operations and without tediously combing through records. For purposes of describing exemplary embodiments of this invention, FIGS. 1 and 2 comprise a generic description of the principles of this invention in the abstract. FIGS. 3-8 comprise wireline, wireless, and VoIP, respectively, implementations of exemplary embodiments of this invention. FIGS. 9-12 comprise flow charts of one embodiment of the Retrieval system of FIG. 2.

Referring to FIG. 1, a communications network 100 in which an exemplary embodiment of this invention operates is illustrated in a block diagram. A communications device 110 is connected to or in communication with a service provider network 112. Communications device 110 may be a telephone, a computer, a personal digital assistant (PDA), a TDD device, an interactive television, or any other device that can be used to communication, summon emergency services or both. Communications device 110 communicates by voice or data (e.g., email message, SMS message, Internet message, etc.), or by any other means suitable to request emergency services. As will be discussed further, below, communications device 110 can use wireline technology, wireless technology, or any other type of communications technology.

Most communications devices 110, both landline and mobile, that are associated with the PSTN or a VoIP network, are assigned a telephone number (TN), which is also known in the art as an “automatic number identification” (“ANI”) or, more popularly, “Caller ID.” Although the TN or ANI is often the same as that stored for Caller ID, they are not necessarily the same. For clarity, references herein are generally made to “ANI” alone; however, such references should be understood to include TN, ANI and Caller ID, as known in the art.

Optionally, communications device 110 includes a locator device 113. Locator device 113 comprises an independent means for determining the location of the communications device 110, such as a GPS receiver. Also optionally incorporated with communications device 110 is a comparator 114, which compares location information derived from locator 113 with location information received according to this invention. Locator 113 and comparator 114 may be integral part of communications device 110 in this exemplary embodiment. Alternatively, locator 113 and comparator 114 may be separate from communications device 110 (i.e., after market device or devices), in the manner of many Caller ID devices.

For purposes of describing exemplary embodiments of this invention, the operation of communications network 100 responsive to an emergency call is first described. When the user of communications device 110 makes an emergency services call by dialing or entering an emergency services number (e.g., “9-1-1” in the United States and Canada), the call is received by service provider network 112. The call is routed by and through service provider network 112 to public safety answering point (PSAP) 116 and the ANI of communications device 110 is delivered to PSAP 116. When PSAP 116 receives the call, it determines the location of communications device 110. To this end, PSAP 116 sends the ANI of communications device 110 through interface 118 to emergency response information source 120. For purposes of this description, source 120 comprises an automatic location information (ALI) system. Source 120 applies the ANI of communications device 110 to source database 122 and returns emergency response information through interface 118 to PSAP 116. Such emergency response information includes, but is not limited to, the location of communications device 110 and optionally other medical, personal, environmental, etc. information. The emergency response information available from source 120 and source database 122 includes pre-provisioned information, as is generally the case for wireline communications, or information provisioned at about the time of a call for emergency services, as is generally the case for wireless communications.

According to the general exemplary embodiment of this invention, the user of communications device 110 can now verify most or all of the emergency response information stored in source database 122. This advance is achieved in the art by a retrieval system 130 communicatively coupled to service provider network 112 via an appropriate network interface 132, or, alternatively, directly. Retrieval system 130 is described more fully, below, in connection with FIG. 2. In accordance with the exemplary embodiment given above, network interface 132 comprises a termination point on service provider network 112. Network interface 132 may have a TN or may have an abbreviated dialing code assigned to it so that service provider network can route a call to it as is known in the art.

As set forth above, this invention effects retrieval, verification, or both of the emergency response information stored in source database 122 associated with communications device 110. Continuing with the description of this exemplary embodiment, the user of communications device 110 dials the TN or special number code of network interface 132. Service provider network 112 routes the call and connects the call to network interface 132. Service provider network 112 also delivers the ANI of communications device 110 to network interface 132.

Network interface 132 delivers any and all information obtained (from service provider network 112, directly from communications device 110, from the user of communications device 110, or a combination thereof) to retrieval system 130 according to this invention. Such information at least includes, but is not limited to, the ANI of communications device 110. Retrieval system then sends a request for emergency response information to source 120, advantageously through source interface 134 and forwards the ANI of communications device 110.

In accordance with one aspect of this invention, source interface 134 is advantageously the same as or similar to source interface 118. Such similarity helps to insure that the emergency response information obtained from source 120 is identical to that obtained by PSAP 116. Alternatively, retrieval system 130 may be connected to interface 118 directly. Source 120 may use relatively static data such as from a data store 122 (typically an ALI database in the USA), data store 144. Alternatively, source 120 obtains relatively dynamic data, such as a mobile positioning center (MPC) used in ANSI CDMA and TDMA networks, a GMLC used in GSM networks, a positioning server used for VoIP communications services, or another means for determining call origin location information that is intended to be presented to PSAP 116 with respect to communications device 110. Such embodiments are discussed further, below.

In this exemplary embodiment, when source 120 receives the emergency response information request from retrieval system 130 (which includes the ANI), source 120 queries source database 122 using the ANI as a key. The information associated with the ANI of communications device 110 is returned to source 120, and is forwarded through source interface 134 to retrieval system 130. Retrieval system 130 formats and sends the emergency response information to network interface 132. Alternatively, retrieval system 130 forwards the raw data from source 120 to network interface 132, and network interface 132 formats the data for delivery to communications device 110 via service provider network 112.

If communications device 110 includes locator 113 and comparator 114, it may automatically compare at least the location information received from source 120 to location information obtained by locator 113. Thus, the emergency response information can be verified by the user of communications device 110 simply and efficiently in accordance with this invention.

Additionally, and in accordance with another aspect of this invention, a user may add, delete or otherwise edit any or all of the emergency response information. Retrieval system 130 may be programmed to receive changes to fields in the emergency response information in a manner that is appropriate to the type of communications device 110. For purposes of this explanation of this exemplary embodiment, retrieval system 130 comprises an interactive voice recognition system.

In this exemplary embodiment, the interactive voice response system prompts the user of communications device 110 for any changes and the user speaks or keys in the correct information. When the editing is complete, retrieval system delivers the updated information to source 120 via source interface 134 to be stored in source database 122. Advantageously, a signal or flag is set in source 120 that emergency response information for communications device 110 was changed by the user, so that normal updates, as will be described below, do not overwrite valid changes.

As is known in the prior art, an emergency response information data management system 140 provides emergency response information to source 120 over a data distribution network 142. Emergency response information data management system 140 includes a data store 144. Communications services providers supply emergency response information to emergency response information data management system 140 via one or more provisioning distribution networks, represented by provisioning distribution network 146, from such providers' provisioning system 150. Provisioning system 150 includes a data store 152. Provisioning system 150, provisioning distribution network 146, data management system 140 and data distribution network 142 are all well known in the art and therefore not discussed further.

In accordance with another aspect of this invention, retrieval system 130 may gather data for verification and update data anywhere along the above data path. In this alternative embodiment, retrieval system 130 is connected to data management system 140 via source interface 134 via dotted line 160. Alternatively, retrieval system 130 is connected to provisioning system 150 via dotted line 162. Of course, retrieval system may be connected any one of source 120, data management system 142 and provisioning system 150, or any combination thereof. One skilled in the art will appreciate which architecture is appropriate for a specific application after studying this specification.

One skilled in the art will also appreciate that the optimal block for retrieval of information is source 120, so that the emergency response information obtained at communications device 110 is identical to, or as nearly identical as possible, to the emergency response information delivered to PSAP 116 in a real emergency. If it is not practical or possible to obtain information directly from source 120, then using connection 160 to data management system 140 is generally the next most desirable block, followed by connection 162 and provisioning system. This hierarchy generally accounts for errors that may occur in the distribution chain.

In accordance with an aspect of this invention, connections 160 and 162 from interface 134 between retrieval system 130 and data management system 140 and between retrieval system 130 and provisioning system 150 facilitate corrections to emergency response information. These corrections are based on feedback received by retrieval system 130 from users of retrieval system 130. Connections 160 and 162 are fully automated to integrate such corrections with normal workflow of data management system 140 and/or provisioning system 150. To facilitate such automation, data management system 140 and/or provisioning system 150 compare correction requests against an heuristic rule set to determine which correction requests can be processed automatically and which require semi-manual or manual research and correction. A record indicator that identifies a correction made to emergency response information based on a correction request received by retrieval system 130 is used to prevent overwriting of corrected data by erroneous data that may not have yet been corrected in provisioning system 150 or elsewhere.

Correction requests requiring semi-manual or manual research or correction are placed in a queue according to this invention. Access to the queue is made available to a plurality of interested parties to facilitate triage of the correction requests and actual correction of emergency response information. Interested parties include, but are not limited to, the 9-1-1 Service provider, any vendors to whom the 9-1-1 Service provider out sources any operations of the 9-1-1 Service, carriers whose emergency response information is subject to a correction request, and appropriate government agencies.

Service provider network 112 may be any type of network, as will be discussed further, below in connection with each specific embodiment. For example, if communication device 110 is a plain old telephone service—type telephone, then service provider network 112 is a public switched telephone network (PSTN). If communication device 110 is a mobile telephone, then service provider network comprises a mobile switching network. Alternatively, if communications device 110 is a digital data device, such as a voice over Internet protocol (VoIP) device, then service provider network 112 comprises a data network, which may include one or more private data networks, one or more public data networks (i.e., the Internet) or a combination thereof. Thus, one skilled in the art will appreciate that service provider network 112 comprises any network or networks that are appropriate for communications device 110, including without limitation, circuit switched networks, packet-switched networks, cable networks, wireless networks, and PBX networks.

One skilled in the art will appreciate that network interface 132 comprises any interface appropriate for communication between retrieval system 130 and communications device 110, given the technologies employed by communications device 110 and the service provider network or networks 112. Therefore, one skilled in the art will be able to implement an interface appropriate for a specific application after studying this specification. For example, if communications device 110 is for voice communications, then interface 132 comprises, in one exemplary embodiment, an interactive voice response system. If communications device 110 comprises a PDA, personal computer, or interactive television, then interface 132 comprises a web server. If, in still yet another embodiment, wherein communications device 110 directly connects to retrieval system 130, then interface 132 comprises an interface usable for such a direct connection.

Turning now to FIG. 2, a retrieval system 130 is shown in block diagram. In accordance with an exemplary embodiment of this invention, retrieval system 130 generally includes a security subsystem 202, a query processing subsystem 204, an administrative subsystem 206 and a data store 208. Optimally, security subsystem 202 is connected between network interface 132 and query processing subsystem 204 to authenticate communications devices 110 before being allowed to access emergency response information. Security subsystem 204 will be discussed further, below.

Query processing subsystem 204 comprises any means for retrieving data, such as, but not limited to, a computer operated by appropriate software, an appropriately programmed switch in an intelligent network, or other device capable of retrieving emergency response information and presenting it to communications device 110. Query processing subsystem 204 receives the request for emergency response information, formats a query to source 120, and sends the request via source interface 134. Query processing subsystem 204 also receives emergency response information from source 120 (via source interface 134), formats the information in a manner appropriate for communications device 110 and delivers the information via network interface 132. Administrative subsystem 206 tracks all queries and stores information in data store 208. Such information may be useful, for example, in an embodiment wherein retrieval system 130 cannot effect changes directly on source 120 (or data management system 140 or provisioning system 150). In this exemplary embodiment, the service provider periodically checks for changes in data store 208 and applies the changes, optimally after verification.

As mentioned above, security subsystem 202 authenticates that the consumer, business, government or other entity seeking access to retrieval system 130 has permission or privilege to do so. Such authentication is desirable to prevent retrieval system 130 from being misused, for example, to prevent a criminal from identifying the name and addresses of potential victims. One skilled in the art will understand how to implement a security subsystem 202 that is appropriate for the type of communications device 110 and network 120 (if any) used for communication with retrieval system 130, such that access to retrieval system 130 is restricted to only those who are authorized to have such access. Various systems that can be used for security subsystem 202 are well known in the art, some of which are described below.

In an embodiment of the invention wherein interface 132 comprises an interactive voice response system, security subsystem 202 identifies the caller's network ANI or Caller ID, and allows access through retrieval system 130 only to emergency response information associated with that ANI or Caller ID. If communications device 110 is configured to block disclosure of its ANI or Caller ID, security subsystem 202 prevents retrieval and disclosure of any emergency response information.

In an exemplary embodiment of this invention wherein interface 132 comprises a web server (e.g., the website of the carrier providing communications service for communications device 110) the authentication process required by the carrier's website—typically, user name and password—is used as input into security subsystem 202. In this embodiment, the carrier's website is enhanced to perform the retrieval and verification of emergency response information directly. Alternatively, the carrier's website provides a link to a verification website, and then employs a reverse proxy or other secure means to pass a secure session to retrieval system 130. A user of such web access advantageously retrieves and verifies emergency response information for all telephone numbers in that user's account, rather than only the emergency response information associated with the ANI for the communications device 110 used to contact retrieval system 130.

In another exemplary embodiment of this invention, a class of users is authorized to connect to interface 132 directly. In accordance with this embodiment, access to retrieval system 130 is configured for each entity authorized for such direct connection. The configuration is stored in data store 208 and then used by security subsystem 202 to control such direct access to retrieval system 130. This configuration is accomplished by permitting terminal access to retrieval system 130 (not shown) by an administrator or via remote configuration using means as is known in the art.

In another exemplary embodiment of the invention, security subsystem 202 comprises part of source 120, either by associating an authorization indicator with emergency response information, or by using a database table indicating which entities have permission to access emergency response information and, advantageously, the extent of access authorized. Such database table can be located at source 120 or in a satellite database system (not shown, but well known in the art).

The extent of access to retrieval system 130 can be restricted to emergency response information associated with an individual TN or multiple TNs, all TNs associated with a specific TN account, all TNs within a specified range of TNs, or other schema. Such extent of access could also be restricted by region or be relatively unrestricted. State law enforcement entities, for example, could be authorized access emergency response information associated with any TN in their state jurisdiction.

Preferably, query processing subsystem 204 retrieves emergency response information from source 120 via interface 134, which comprises an interface that is appropriate to the particular source 120. Query processing subsystem 204 presents such retrieved emergency response information to communications device 110. Alternatively, query processing subsystem 204 retrieves emergency response information from data management system 140, or from provisioning system 150. In these alternative embodiments, retrieval system 130 is communicatively coupled to an interface 134 that is appropriate to the system 140 or 150 from which emergency response information is retrieved. As above, query processing subsystem 204 then presents such retrieved emergency response information to communications device 110.

As stated above, retrieving emergency response information from source 120 is preferred because such information is live data; that is, the retrieved emergency response information is the same as that presented to PSAP 116. Hence, the data contains any and all errors that might have been introduced at any step in the process of providing such emergency response information to PSAP 116. Likewise, using an existing interface that is supported by the existing emergency services network, such as interface 134, is preferred for the same reason; that is, any errors introduced to the emergency response information by interface 134 would also be retrieved for verification by the user of communications device 110.

Before presenting emergency response information to communications device 110, such information optionally may be passed through a translation function (not shown) to convert any MSAG valid community name contained in such information to the corresponding postal city name, to reduce the number of correction requests based on the differences that sometimes exist between valid community names in the master street address guide (MSAG) and postal city names.

As stated above, interface 134 comprises an interface supported by the existing emergency services network, such as interface 118 (FIG. 1) that is used by PSAP 116. In this embodiment, query processing subsystem 204 performs a TN query of source 120 where the query itself is identical to queries from any other PSAP controller. Alternately, interface 134 may comprise a newly created or pre-existing steering interface for retrieving emergency response information from an alternative database, including, but without limitation, data store 144, data store 152 or another data store.

Steering interfaces in use today include the PSAP-to-ALI-Message (PAM) interface, the E2 interface described in TIA/EIA/J-STD-036 used for delivering Phase 2 emergency service calls in a wireless network, E2+ interface (a further evolution of the E2 interface), and XML-ALI-to-ALI-Messaging (XAAM) interface. The later interface provides for retrieval of selected fields using an XML-like tagged interface. Interface 134 can be an administrative interface used by a 9-1-1 service provider, thereby allowing indirect access into source 120. On skilled in the art will understand how to build interface 134, after studying this specification, for any technology, including, but without limitation, web, TCP/IP, and TCAP.

For certain ANI's, call origin location information is not provided to data store 122 except as the result of processing a live call for emergency services, such as for wireless or out-of-region ANI's. Even then, such information might not be presented to PSAP 116, as for example, if the technology used by PSAP 116 does not yet handle such information. Moreover, for a communications device 110 that is wireless, identification of the accuracy of location information that is provided to PSAP 116 is more important, given the mobility of a wireless communications device 110. Thus, certain emergency response information associated with a communications device 110 having a wireless TN that could be presented to PSAP 116 may be expressed as (a) the type of location information (e.g., Phase 0—TN with no location information, Phase 1—TN and cell site identification, or Phase 2—TN with longitude and latitude), (b) the actual location information itself (e.g., cell site location description, longitude and latitude, or street address), and/or (c) the estimated accuracy of such location information (e.g., within 1 km of actual location, within 100 m, etc).

Implementation of multiple embodiments of the invention simultaneously can be facilitated for those embodiments using an interactive voice response system by including a prompt asking whether emergency response information is sought for a TN associated with wireline, wireless, VoIP, cable, or other communications technology. Alternatively, differentiated access to an appropriate embodiment of the invention can be arranged by using differentiated calling numbers or other addressing for users of wireline, wireless, VoIP, cable, or other communications technology. Yet another alternative would be to use security subsystem 202 to obtain information to make such differentiation.

Further, network interface 132, retrieval system 130 and source interface 134 are illustrated herein as three separate entities. One skilled in the art will realize, after studying this specification, that network interface 132, retrieval system 130 and source interface 134 may be one, two, or more separate entities. Additionally, network interface 132, retrieval system 130 and source interface 134 may be combined, individually or in combination, with other portions of communications network 100. For example, network interface 132, retrieval system 130 and source interface 134 may be a part of source 120. Network interface 132, retrieval system 130 and source interface 134 may be included in a service control point (SCP) in service provider network 112. Such SCP's are well known in the art and thus one skilled in the art will be able to program an SCP to include the functionality of the network interface 132, retrieval system 130 and source interface 134 after studying this specification.

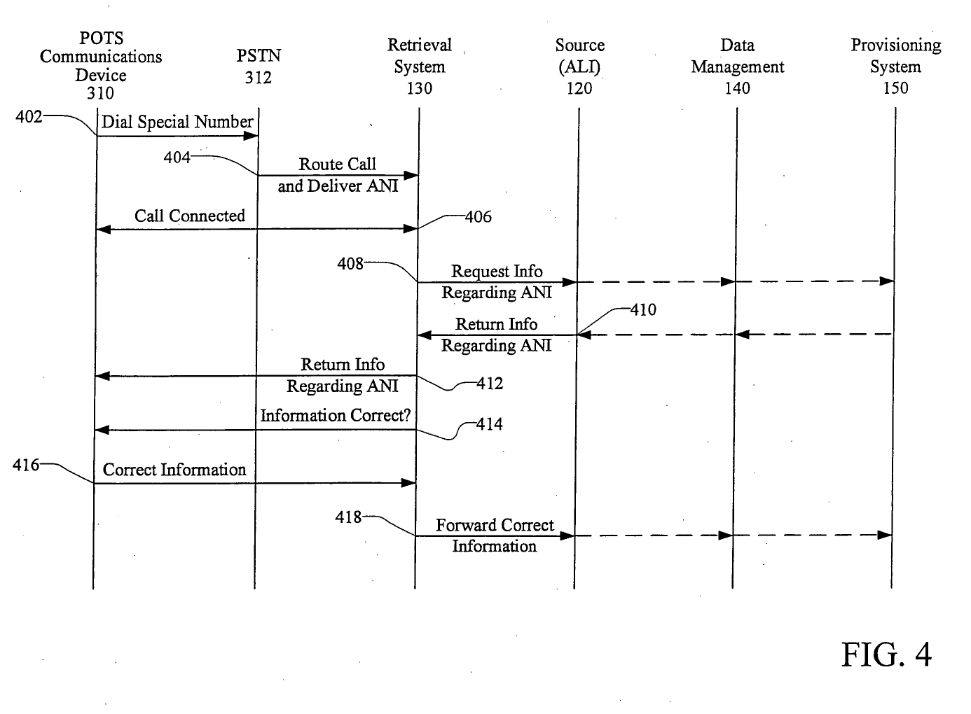

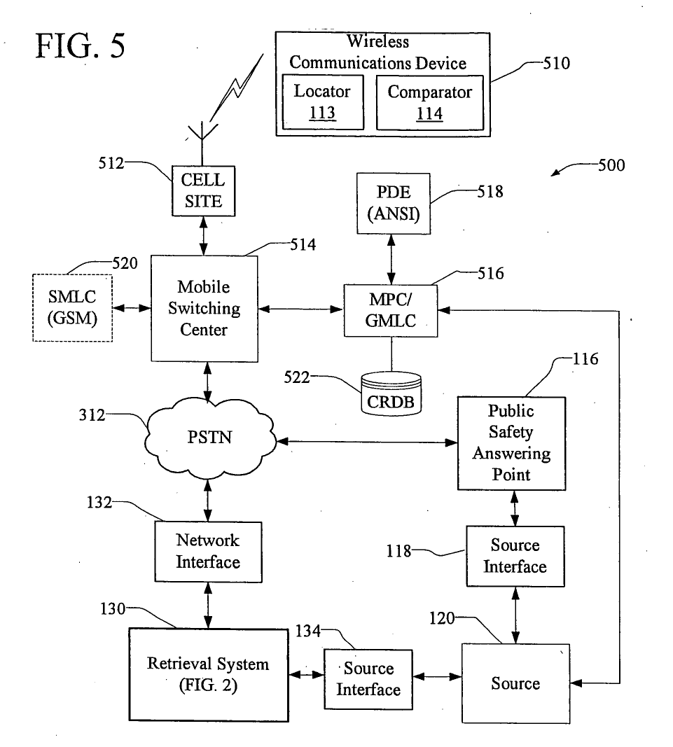

Turning now to FIGS. 3 and 4, a plain old telephone service (POTS), landline implementation of the current invention is shown in block diagram in FIG. 3. FIG. 4 illustrates a call flow of this exemplary embodiment of this invention in the context of FIG. 3. Thus, FIGS. 3 and 4 will be described together, with call flow steps of FIG. 4 inserted in parenthesis.

In FIG. 3, a POTS communications device 310 (optionally including a locator 113 and comparator 114) dials a special number (e.g., a predefined 10 digit number or an abbreviated number such as 9-2-2). The call is received by local switching system 311, which recognizes the special number. (402) Local switching system 311 routes the call through PSTN 312, forwarding the ANI of POTS communications device 310. (404) PSTN 312 routes the call to retrieval system 130 via network interface 132 and delivers the ANI. The call is connected between retrieval system 130 and POTS communications device 310. (406) For purposes of explaining this exemplary embodiment of this invention, assume that network interface 132, retrieval system 130, or both comprise an interactive voice response system.

Retrieval system 130 sends the ANI to source 120 via source interface 134 to request information associated with the ANI (and hence POTS communications device 310). (408) Optionally, the request may be sent to data management system 140, provisioning system 150 or a combination of source 120, data management system 140 and provisioning system 150 (represented by the dashed arrows). Any information found that is associated with the ANI is returned to retrieval system 130. (410) Retrieval system 130 formats the information and returns the information to POTS communications device 310. (412) In the embodiment wherein network interface 132, retrieval system 130 or both comprise an interactive voice response system, the information returned is formatted into speech.

Retrieval system 130 then optionally requests whether the information is correct. (414) If the information is correct, the user of POTS communications device 310 may hang up or otherwise positively acknowledge retrieval system. If the information is not correct, the user of POTS communications device 310 enters the correct information, via, for example, dual-tone, multi-frequency signals or spoken words. The corrections may be recognized via speech recognition or may be recorded for manual entry at a later time. (416) The corrections are then forwarded to the source 120 and/or to data management system 140 and provisioning system 150. (418)

FIG. 5 illustrates an exemplary embodiment of this invention applied to a wireless communications environment 500. Wireless communications environment 500 comprises a Global System for Mobile Communications (GSM) or an American National Standards Institute (ANSI) code division multiple access (CDMA), or time division multiple access (TDMA) as are known in the art. This exemplary embodiment of wireless communications environment 300 is described in terms of ANSI and GSM communications systems. While these systems generally function similarly, differences will be noted in the text and in FIG. 5.

Wireless communications device 510 is in wireless communication with cell site 512. Advantageously, wireless communications device 510 includes a locator 113 and optionally a comparator 114, as described in connection with FIG. 1. Cell site 512 is representative of a plurality of cell sites as are used in a wireless communications environment 500 as is known in the art. The plurality of cell sites, including cell site 512, is connected to a mobile switching center (MSC) 514, either directly or via one or more base station controllers (not shown but well known in the art. MSC 514 is connected to a mobile position center (MPC) or global mobile location center (GMLC), herein called “MPC/GMLC 516,” as is known in the art.

When a communications device, such as communications device 510, dials 9-1-1 in wireless communications environment 500, cell site 512 forwards the dialed digits to MSC 514. In order to route the call to the proper PSAP, MSC 514 determines the location of communication device 510. MSC 514 queries MPC/GMLC 516 for routing instructions, passing it the ANI of the communications device and an identifier for the cell sites serving a call. MPC/GMLC 516 requests the location of communications device 510 from position determining entity (PDE) 518 (in accordance with ANSI systems) or from serving mobile location center (SMLC) 520 via MSC 314 (in accordance with GSM systems). PDE 518 or SMLC 520 returns the X/Y coordinates of mobile communications device 510 to MPC/GMLC 516. MPC/GMLC 516 then applies these coordinates to a coordinate routing database (CRDB) 522. CRDB 522 generally comprises a mapping of geographical locations served by wireless communications system 500 to a serving PSAP.

In this exemplary embodiment, the serving PSAP for communications device 510 is PSAP 116. CRDB 522 returns routing instructions for PSAP 116, which generally comprises the emergency services routing zone (ESZ) of PSAP 116. MPC/GMLC 516 assigns an appropriate ESRK to route the call to the PSAP and sends the ESRK to MSC 514. MSC 514 routes the call through service provider network, which, in this exemplary embodiment, comprises PSTN 312 to PSAP 116 passing the PSAP 116 an emergency services routing key (ESRK) that was assigned to this emergency call.

PSAP 116 passes the received ESRK to source 120 via source interface 118. Source 120 recognizes ESRK as a special number and sends a message to MPC/GMLC 516 requesting information associated with the ESRK. MPC/GMLC 516 returns the X/Y coordinates and any additional information regarding communications device 510 to source 120. Source 120 delivers this information to PSAP 116 via source interface 118.

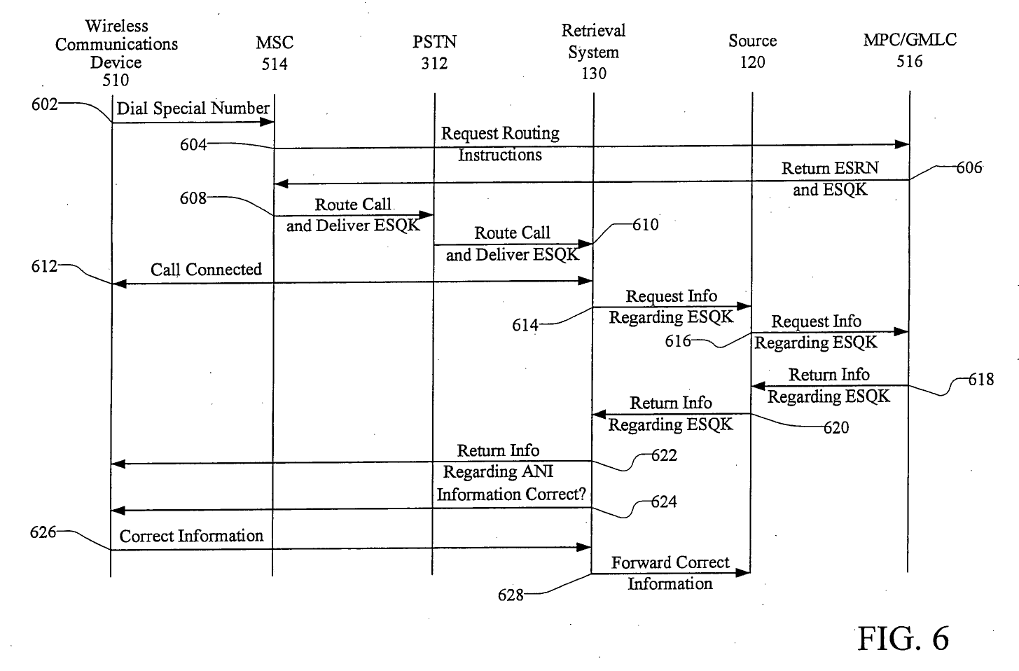

The operation of an exemplary embodiment of this invention is now described using the block diagram of FIG. 5 in the context of the call flow diagram of FIG. 6, as above. In accordance with this embodiment of this invention, MSC 514 is programmed to recognize a special numbering sequence, such as a specially-designated, standard ten-digit telephone number or an abbreviated number such as 9-2-2, to access retrieval system 130, and to perform special call processing. Thus, when mobile communications device 510 dials a special number sequence, the call is directed through cell site 512 to MSC 514. (602) MSC 514 requests routing instructions from MPC/GMLC 516 (604), which returns an ESRN and ESQK for this call, wherein the ESRN represents retrieval system 130. (606)

In this exemplary embodiment, MSC 314 sends an ESQK associated with the ANI of wireless communication device 510 to the PSTN 312. (608) PSTN 312 routes the call to retrieval system 130 based on the ESRN and delivers the ESQK. (610). A call is then completed between wireless communications device 510 and retrieval system 130. (612) Retrieval system 130 queries source 120 via interface 134 to determine the actual call origin location for communications device 510. (614) Source 120 recognizes the ESQK as a special number and requests location information from MPC/GMLC 516. (616) MPC/GMLC 516, in response, requests location information from PDE 518 or SMLC 520.

MPC/GMLC 516 returns any or, preferably, all information it has regarding the ESQK back to source 120. (618) Source 620 forwards the information to retrieval system 130. (620) Retrieval system 130 formats and sends the information it receives back to wireless communications device 510. (622) Optionally, retrieval system 130 can request acknowledgement or correction of the information. (624) Such correctable information may include name and address associated with wireless communications device 510. Corrected information may be sent from wireless communications device 510 back to retrieval system 130 (626), which forwards the corrected information to source 120. (628) Note that, in the above embodiment, MPC/GMLC 516 is approximately analogous to data management system 140 (FIG. 1). Further, PDE 518 and SMLC 520 are approximately analogous to provisioning system 150 (FIG. 1). This exemplary embodiment reflects the fact that call origin location information is determined dynamically at about the time that a call for emergency services placed, rather than being pre-provisioned to data store 122 (FIG. 1). Thus, retrieval system 130, source interface 134, or both, may be directly connected to any or all of MPC/GMLC 516, PDE 518 and SMLC 520 and retrieve information accordingly.

In another exemplary embodiment, MPC 514 is programmed to recognize the special dialing sequence using a feature request code or a trigger in Intelligent Network (IN) technology. Technologies such as ANSI41, wireless intelligent network (WIN) or advanced intelligent network (AIN) can be used in conjunction with an interactive voice recognition system to listen for tones identifying the feature code for emergency information verification. In response, a message is sent to a home location register (HLR) or a Service Control Point (SCP) (not shown but well known in the art). SCP, HLR or both are programmed to recognize the special numbering sequence as indicating a request to retrieve and verify emergency response information and to respond accordingly. Retrieval system 130 in this case comprises an HLR; an SCP or MPC in an ANSI network; or a GMLC in a GSM network. The HLR, SCP, MPC, or GMLC is programmed to perform the function of retrieval system 130. In accordance with one aspect of this invention, retrieval system 130 uses the cell site ID to perform a database look-up to retrieve the cell site location description directly from CRDB 522, and pass the description to wireless communications device 510. The description may be passed back to wireless communications device 510 in the voice band, via a signaling channel via an SMS system or other data communication system.

This embodiment is particularly useful for wireless service providers when performing Phase 2 location testing in the field, because the tester can now receive real time feedback as to the performance of the E911 systems. The tester can immediately log a comparison, made either manually or by use of comparator 114, of (a) the current field results obtained by using an independent means to determine the tester's location (such as a GPS device) or locator 112, and (b) results from using an embodiment of the invention. This allows the tester to avoid post field research data correlation and comparison; thus saving time without wasting resources.

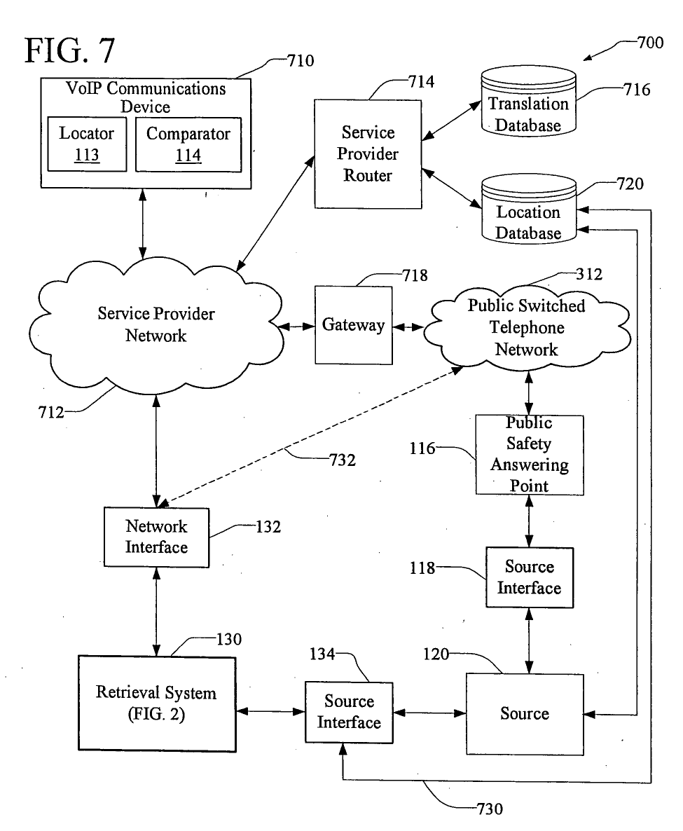

Turning now to FIG. 7, a block diagram of an embodiment of this invention in a VoIP technology environment is shown. In the exemplary embodiment of FIG. 7, communications device 710 comprises a VoIP communications device, which is connected to a VoIP service provider network 712. VoIP communications device 710 may include a locator 113 and comparator 114, as described above. As is known in the art, a service provider router 714 receives all call originations from VoIP communications device 710 and translates dialed digits by applying the dialed digits to a translation database 716. Translation database 716 includes routing instructions for routing calls within service provider network 712 and to the PSTN 312 via one or more gateways, represented by gateway 718.

The following is a generalized description of routing of emergency calls in a VoIP communications network, such as VoIP communications network 700. As of the time of filing of this patent application, there are no standards in the industry as there are in wireless and wireline telephony. Thus, the system and method follows the wireline system and method wherever possible.

When VoIP communications device 710 dials 9-1-1, service provider router 714 determines that the special number call requires special routing from translation database 716. Service provider router 714 obtains special routing information from location database 720, including, but not limited to, an ESRN and an ESQK and optionally the service provider network address of gateway 718. The 9-1-1 call from VoIP communications device 710 is then routed through service provider network 712 to gateway 718. Gateway 718 connects the call to PSTN 312, passing to PSTN 312 the ESRN as the dialed number and the ESQK as the dialing number or ANI. PSTN 312 uses the ESRN to route the call to the PSAP that serves the location of VoIP communications device 710 (as determined in location database 720), which, in this exemplary embodiment, is PSAP 116. The call is connected to PSAP 116 and, as in the case of a wireless call, PSAP 116 passes the ESQK through source interface 118 to source 120. Source 120 recognizes a special number call from the ESQK and sends a message to location database 720. Location database 720 returns location information regarding VoIP communications device 710 to source 120, which then forwards the location information to PSAP 116 via source interface 118.

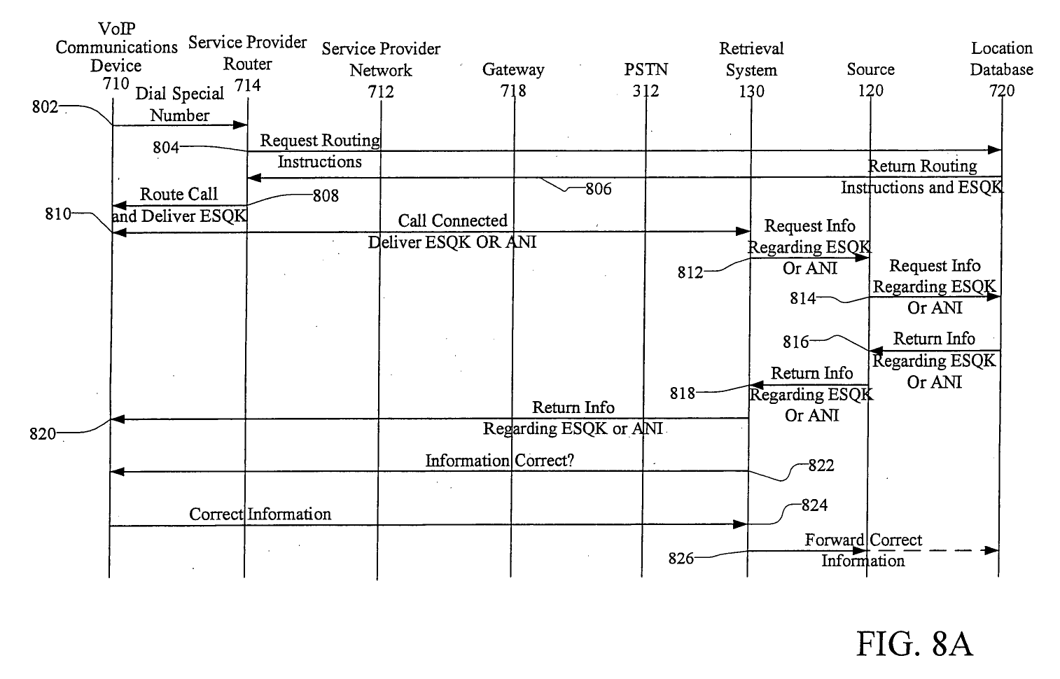

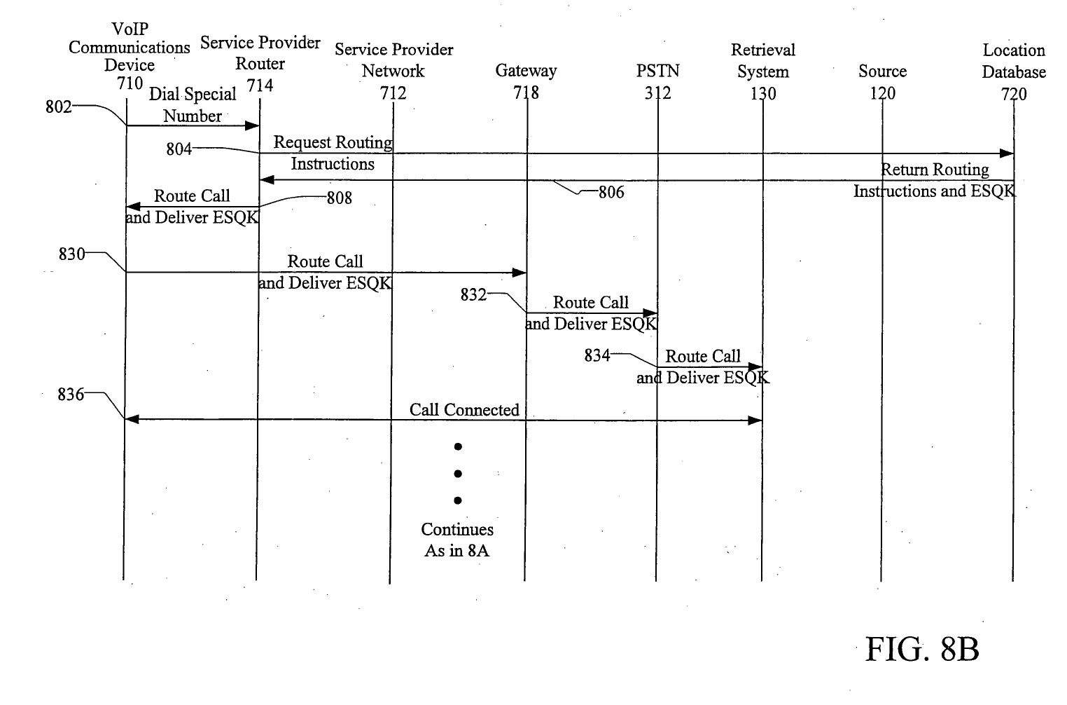

An exemplary embodiment of this invention in the context of VoIP communications network 700 is now described in conjunction with the call flow of FIG. 8A, as above. In accordance with this exemplary embodiment of this invention, the user of VoIP communications device 710 may check (at least) its location information. The user of VoIP communications device 710 dials a special 10-digit number, or, alternatively, an abbreviated number (such as 9-2-2). The call origination is delivered to service provider router 714, which recognizes the dialed number as requiring special handling. (802) Service provider router 714 applies the dialed number to translation database 716, location database 720 or both, in order to determine how to route the call. (804)

In one exemplary embodiment, service provider router 714 routes the call through service provider network 712 directly to network interface 132. Thus, location database 720 returns routing instruction and, optionally, an ESQK. (806) Service provider router 714 sends routing instructions back to VoIP communications device 710 and advantageously an ESQK. (808) VoIP communications device 710 then routes the call through service provider network 712 to retrieval system 130, via network interface 132, sending its ANI, the optional ESQK, or both. (810) In this exemplary embodiment, network interface 132 comprises a gateway or similar IP interface. Retrieval system 130 comprises an interactive voice recognition system. Alternatively, if VoIP communications device comprises a device capable of communication via text, graphics or both, retrieval system 130 includes a text, graphics, or both, system. Advantageously, retrieval system 130 is configured to include both an interactive voice recognition system and a text or graphics communications system.

Retrieval system 130 sends the received ANI, ESQK or both to source 120 via source interface 134. (812) Source recognized the special nature of ESQK (as it would in a real 9-1-1 call), and queries location database 720 for location information. (814) Location database 720 returns emergency information back to source (818), which returns the emergency information back to VoIP communications device 710. (820) Advantageously, retrieval system 130 queries the user of VoIP communications device whether the emergency information is correct. (822) The user may optionally send correct information to retrieval system 130 (824), which forwards the correct information to location database 720, or other network element. (826)

In another alternative embodiment, source 120, retrieval system 130 or both communicate with service provider router 714 to request location information. Service provider router 714 then retrieves location information from location database 718. Alternatively, retrieval system 130 is configured to query location database 720 directly, in accordance with one aspect of this invention, along path 730. In this exemplary embodiment, source interface 134 is configured to communicate directly with location database 720 directly. Retrieval system 130 then forwards location data received from location database 720 back to VoIP communications device 710 via network interface 132 and service provider network 712, either verbally or graphically.

Another exemplary embodiment of this invention is now described in the context of FIG. 7 and the call flow diagram FIG. 8B. In this exemplary embodiment, the call setup to verify emergency information is parallel to call setup for a real emergency call. The user of VoIP communications device 710 dials a special 10-digit number, or, alternatively, an abbreviated number (such as 9-2-2). The call origination is delivered to service provider router 714, which recognizes the dialed number as requiring special handling. (802) Service provider router 714 applies the dialed number to translation database 716, location database 720 or both, in order to determine how to route the call. (804)

In one exemplary embodiment, service provider router 714 routes the call through service provider network 712 to gateway 718 and into PSTN 312. Thus, location database 720 returns routing instructions (such as an ESRN) and an ESQK. (806) Service provider router 714 sends routing instructions back to VoIP communications device 710 and advantageously an ESQK. (808) VoIP communications device 710 routes the call through service provider network 712 to gateway 718. (830) Gateway 718 uses the routing instruction to route the call into PSTN 312. (832) The call is then routed through PSTN 312 to network interface 132 (over dashed line 732). (834) In this exemplary embodiment, network interface 132 operates in the same manner as it does in FIG. 3. Network interface 132 delivers the query and any data received to retrieval system 130. The call is now complete between VoIP communications device 710 and retrieval system 130. (836) Call processing continues as in FIG. 8A, described above. As in the above exemplary embodiment, retrieval system 130 obtains location information either directly (via path 730) or from source 120.

FIGS. 9A-9C illustrate one exemplary flow of interactive sequences of the invention, for a consumer using an embodiment in which interface 132 or retrieval system 130 comprises an interactive voice recognition system. The same or different sequences can be used for other embodiments, and different sequences can be used for this embodiment. In general, the sequence can include any or all of the following steps.
(a) Process starts at 902 of FIG. 9A.
(b) At 904, a consumer calls retrieval system 130 (FIG. 1) using communications device 110. After being vetted by security subsystem 202 (FIG. 2), the process continues.
(c) (Not shown) The consumer selects a language preference. Language preference options presented may be customized by geographic region, or the system could be programmed to remember the language preference previously selected by each entity. The process continues at 906.
(d) At 906, retrieval system 130 determines whether an ANI is delivered with the consumer's call. If not, the process continues at 908; otherwise, the process continues at 910.
(e) At 908, the consumer is informed that retrieval system 130 cannot process the consumer's call because the consumer's ANI (“caller ID”) is blocked. The consumer is invited to try again after unblocking caller ID or to contact the consumer's communications services provider. The process continues through connector A to FIG. 9B.
(f) At 910, retrieval system 130 determines whether there are any outstanding requests to correct emergency response information associated with the ANI associated with communications device 110. If so, the process continues at 912; otherwise, the process continues through connector B to FIG. 9B, 914.
(g) At 912, the consumer is informed that an earlier correction request is outstanding. Consumer is invited to call again or to contact the consumer's communications provider. Processing continues through connector B to FIG. 9B
(h) At 914 in FIG. 9B, retrieval system 130 attempts to retrieve emergency response information associated with the ANI of communications device 110. If information is found, the process continues through connector C to FIG. 9C; otherwise, the process continues at 916.
(i) At 938 of FIG. 9C, the emergency response information is presented to the consumer, who is prompted to confirm whether it is accurate. The consumer is given the option to confirm that the information is correct, in which case the process continues at 942; to request correction of the information, in which case the process continues at 940; or to have the information repeated, in which case the process continues at 944. If none of these options is selected, the process continues at 944.
(j) At 940, the process continues through connector D to FIG. 9B.
(k) At 942, the process continues to 948.
(l) At 948, the consumer is thanked. The process continues through connector E to FIG. 9B.
(m) At 944, the system determines whether it is at this point in the sequence because (a) the information has been repeated a preset number of times, in this example, three times; (b) a selection other than one of the options presented was made; or (c) no selection was made within a preset period of time. The process continues at 946.
(n) At 946, if the reason for being at 944 was (a), the information having been repeated a preset number of times, then the process continues at 948; otherwise the process returns to 938 where it continues.
(o) At 948, the consumer is thanked. The process continues through connector E to FIG. 9B.
(p) At 916 of FIG. 9B, the consumer is prompted to indicate the type of technology used by communications device 110, in this example selecting from between (a) a wireless or VoIP phone and (b) a wireline phone or other communications device. If (a) is selected, the process continues at 924. If (b) is selected, the process continues at 928. Otherwise, the process continues at 918.
(q) At 918, the system determines whether it is at this point in the sequence because (a) the prompt having been repeated a preset number of times, in this example, three times; (b) a selection other than one of the two options presented was made; or (c) no selection was made within a preset period. The process continues at 920.
(r) At 920, if the reason for being at 918 was (a), the information having been repeated a preset number of times, then the process continues at 922; otherwise the process returns to 916 where it continues.
(s) At 922, the consumer is thanked and informed that the call cannot be processed. The process continues at 950.
(t) At 924, the process continues at 926.
(u) At 926, the consumer is thanked, informed that emergency response information is not available for wireless or VoIP phones, and advised to contact the consumer's communications service provider. The process continues at 950. Alternatively, processing continues at 932 (not shown).
(v) At 928, the process continues at 930.
(w) At 930, the consumer is informed that no emergency response information was found. The process continues at 932.
(x) At 932, the consumer is prompted to record a message containing the consumer's name and any corrections to the emergency response information, such as updated location information associated with communications device 110. The process continues at 934.
(y) At 934, the consumer's message is recorded along with the date and time at which the message was recorded. The process continues at 936.
(z) At 936, the consumer is thanked and informed that the consumer's communications service provider will be asked to update the emergency response information associated with communications device 110. The consumer is invited to call again later or to contact the consumer's communications service provider. The process continues at 950.
(aa) At 950 (reachable from connector A, connector E 922, 926 and 936), the call is terminated and the sequence stopped.

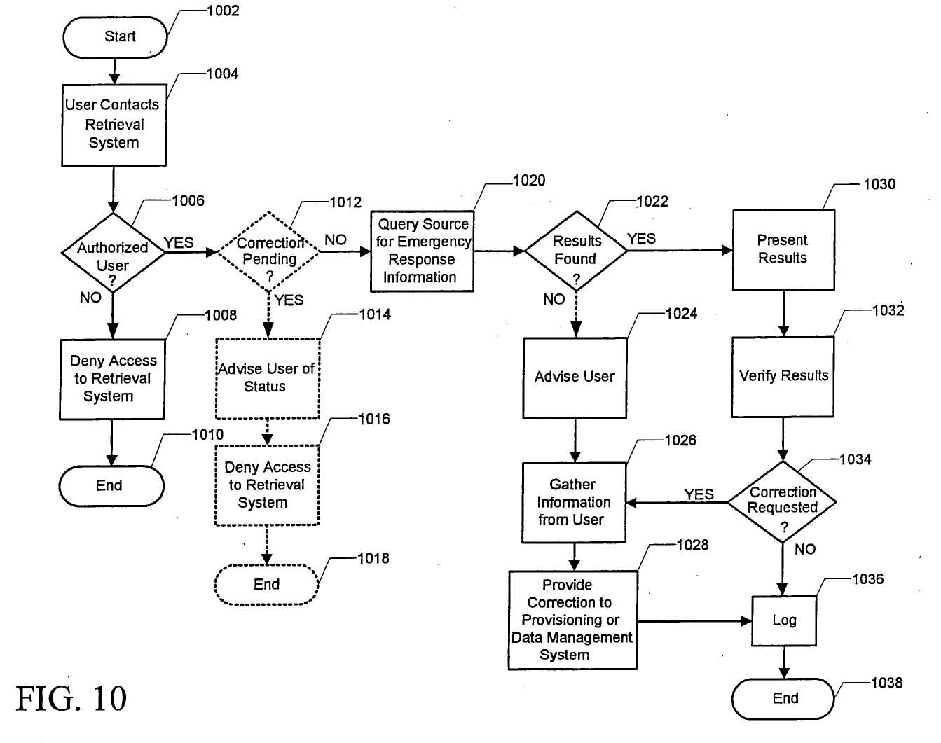

Referring to FIG. 10, one embodiment of a process in accord with the method of the invention is shown in which the interface 132, retrieval system 130, or both, comprise and interactive voice recognition system. The same or different steps can be used for other embodiments, an different steps can be used for this embodiment. Steps 1012, 1014, 1016, and 1018 are depicted in dotted lines to indicate that they are optional steps in the method. Other optional steps can be inserted at this or other points of the method without departing from the spirit of the invention. In general, the method can include any or all of the following steps.
(a) Process starts at 1002.
(b) At 1004, a consumer or other user of the retrieval system 130 uses a communications device 110 to contact the retrieval system 130 using a network or networks 112 that are appropriate for communications device 110 and interface 132. The process continues at 1006.
(c) At 1006, security subsystem 202 determines whether the user is authorized to access retrieval system 130. If authorized, the process continues at 1020, or optionally, at 1012. Otherwise, the process continues at 1008.
(d) At 1008, access to the retrieval system 130 is denied to the user. Optionally, an explanation of the reason for denying access can be provided to the user and/or a recommendation for further action. The process continues at 1010.
(e) At 1010, the process ends.
(f) At optional step 1012, retrieval system 130 determines whether a previous request for correction to emergency response information associated with communications 110 is pending. If so, the process continues at 1014. Otherwise, the process continues at 1020.
(g) At 1014, retrieval system 130 informs the user that a previous requested correction is still pending. The process continues at 1016.
(h) At 1016, access to the retrieval system 130 is denied to the user. Optionally, an explanation of the reason for denying access can be provided to the user and/or a recommendation for further action. The process continues at 1018.
(i) At 1018, the process ends.
(j) At 1020, retrieval system 130 seeks to retrieve emergency response information, preferably from source 160. The process continues at 1022.
(k) At 1022, retrieval system 130 determines whether emergency response information (referred to as “results” in the drawing) is found. If results are found, the process continues at 1030. Otherwise, the process continues at 1024.
(l) At 1024, retrieval system 130 informs the user that emergency response information could not be found. The process continues at 1026.
(m) At 1026, retrieval system 130 gathers information from the user, such as identification and callback number, emergency response information and/or corrections to emergency response information. If no record was previously found, a record is created. The process continues at 1028.
(n) At 1028, retrieval system 130 provides information gathered from the user to the appropriate provisioning system 150 or data management system 140 with a request to investigate and correct the emergency response information associated with the TN of the communications device 110. The process continues at 1036.
(o) At 1030, retrieval system 130 presents to the user the emergency response information retrieved in step 1020. The process continues at 1032.
(p) At 1032, the user verifies the accuracy of the emergency response information presented in step 1030. The process continues at 1034.
(q) At 1034, retrieval system 130 determines whether the user requests any corrections to the emergency response information. If the user indicates that the information is accurate or does not request any correction be made, the process continues at 1036. Otherwise, the process continues at 1026.
(r) At 1036, data regarding the session is logged, which data can include all or any of: date, time, TN, whether emergency response information was located, whether user indicated such information was accurate, whether user requested any correction and if so, the nature of the correction, and the disposition of such request. The process continues at 1038.
(s) At 1038, the process ends.

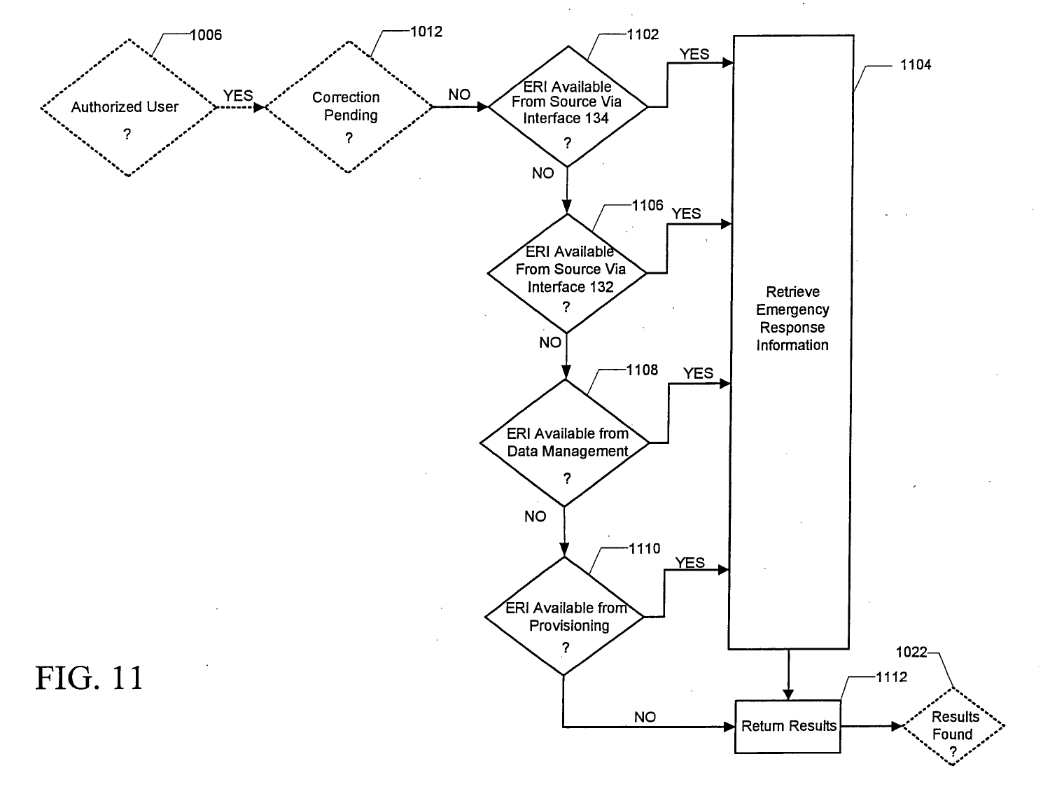

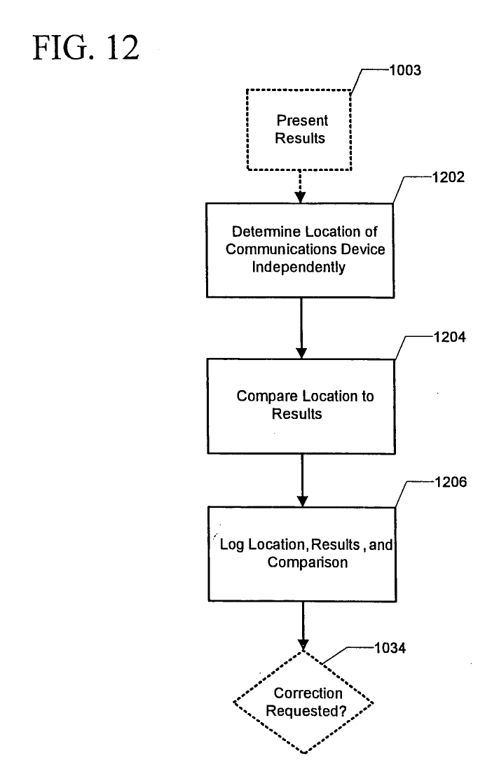

The method just described can be practiced using any form of communications device 110, any form of network appropriate to communications device 110, including without limitation, switched networks, packet networks, the PSTN, the Internet, cable networks, PBX networks, and mobile telephony networks. The TN, i.e., the identifier for communications device 110, can be any way of addressing communications device 110 as described above. Adaptations, additions to, and eliminations of any of the steps just described can be made to reflect the specific form of communications device 110, network or networks 112, and interface or interfaces 132 that are used by one skilled in the art without departing from the scope of the invention. The same is true for steps shown in any of FIG. 9, FIG. 10, FIG. 11, and FIG. 12 or otherwise described herein.

In FIG. 11, for example, one possible adaptation of step 1020 is shown, in which steps 1006, 1012, and 1022 are shown in dotted lines to indicate environment. In this adaptation of 1020, the process proceeds as follows:
(a) At 1102, retrieval system 130 queries source 120 for emergency response information (ERI) via an interface 134 that is supported by the existing emergency services network. If emergency response information is retrievable from source 120 via such interface, the process continues at 1104. Otherwise, the process continues at 1106.
(b) At 1104, retrieval system 130 retrieves the emergency response information. The process continues at 1112.
(c) At 1106, retrieval system 130 queries source 120 for emergency response information via another interface 134. If emergency response information is retrievable from source 120 via such interface, the process continues at 1104. Otherwise, the process continues at 1108.
(d) At 1108, retrieval system 130 queries data management system 140 for emergency response information via interface 134. If emergency response information is retrievable from data management system 170, the process continues at 1104. Otherwise, the process continues at 1110.
(e) At 1110, retrieval system 130 queries provisioning system 150 for emergency response information via interface 134. If emergency response information is retrievable from provisioning system 170, the process continues at 1104. Otherwise, the process continues at 1112.
(f) At 1112, the results are returned. The process continues at 1022.

In FIG. 12, for example, one possible adaptation of step 1032 is shown, in which steps 1030 and 1034 are shown in dotted lines to indicate environment. In this adaptation of 1032, the process proceeds as follows:
(a) At 1202, the location of communications device 110 is determined by an independent means, such as but not limited to, using a GPS device, a map, landmarks, or other means to determine location. Advantageously, this can be accomplished by using locator 112. The process continues at 1204.
(b) At 1204, the location determined in step 1202 is compared to the results obtained in step 630. Advantageously, this can be accomplished by using comparator 113.
(c) At 1206, all or any of the following can optionally be logged at the location of communications device 110: the location determined in step 1202, the results obtained in step 1030, and the comparison made in step 1204.

Advantageously, such logging can be accomplished using comparator 114. The process continues at 1034.

It is to be understood that the above-described embodiments are merely illustrative of the present invention and that many variations of the above-described embodiments can be devised by one skilled in the art without departing from the scope of the invention. It is, therefore, intended that such variations be included within the scope of the following claims and their equivalents.

1. A system for retrieving emergency response information comprising:
a communications device;
a source of emergency response information associated with said communications device; and
a retrieval system communicatingly coupleable with said communications device and with said source, and configured to retrieve said information from said source and to present said information to said communications device.

2. A system as recited in claim 1, wherein said communications device comprises a wireline device.

3. A system as recited in claim 1, wherein said communications device comprises a wireless device.

4. A system as recited in claim 1, wherein said retrieval system is further configured to receive feedback from said communications device, said feedback comprising one or more of the group consisting of:
an acknowledgement of receipt of said information;
a confirmation that said information is accurate;
an indication that said information is not accurate; and
a description of inaccuracy of said information.

5. A system as recited in claim 4, wherein said communications device comprises a wireline device.

6. A system as recited in claim 4, wherein said communications device comprises a wireless device.

7. A system as recited in claim 1, wherein said source is selected from the group consisting of an ALI database, an MPC, an SCP, a GMLC, a location database, a positioning server, a position determining entity, and a data provisioning system.

8. A system as recited in claim 7, wherein said communications device comprises a wireless device.

9. A system as recited in claim 7, wherein said communications device comprises a wireline device.

10. A system as recited in claim 7, wherein said retrieval system is further configured to receive feedback from said communications device, said feedback comprising one or more of the group consisting of:
an acknowledgement of receipt of said information;
a confirmation that said information is accurate;
an indication that said information is not accurate; and
a description of inaccuracy of said information.

11. A system as recited in claim 10, wherein said communications device comprises a wireline device.

12. A system as recited in claim 10, wherein said communications device comprises a wireless device.

13. A system as recited in claim 1, further comprising a security subsystem communicatingly coupled between said communications device and said retrieval system and wherein said security subsystem is configured to permit only authorized communications with said retrieval system.

14. A system as recited in claim 13, wherein said communications device comprises a wireline device.

15. A system as recited in claim 13, wherein said communications device comprises a wireless device.

16. A system as recited in claim 13, wherein said retrieval system is further configured to receive feedback from said communications device, said feedback comprising one or more of the group consisting of:
an acknowledgement of receipt of said information;
a confirmation that said information is accurate;
an indication that said information is not accurate; and
a description of inaccuracy of said information.

17. A system as recited in claim 16, wherein said communications device comprises a wireline device.

18. A system as recited in claim 16, wherein said communications device comprises a wireless device.

19. A system as recited in claim 13, wherein said source is selected from the group consisting of an ALI database, an MPC, an SCP, a GMLC, a location database, a positioning server, a position determining entity and a data provisioning system.

20. A system as recited in claim 19, wherein said communications device comprises a wireless device.

21. A system as recited in claim 19, wherein said communications device comprises a wireline device.

22. A system as recited in claim 19, wherein said retrieval system is further configured to receive feedback from said communications device, said feedback comprises one or more of the group consisting of:
an acknowledgement of receipt of said information;
a confirmation that said information is accurate;
an indication that said information is not accurate; and
a description of inaccuracy of said information.

23. A system as recited in claim 22, wherein said communications device comprises a wireline device.

24. A system as recited in claim 22, wherein said communications device comprises a wireless device.

25. A method for retrieving emergency response information comprising:
receiving a call requesting said emergency response information from a communications device;
retrieving emergency response information associated with said communications device;
delivering said emergency response information associated with said communications device to said communications device.

26. A method as recited in claim 25, wherein receiving a call requesting said emergency response information from a communications device comprises receiving a call requesting said emergency response information from a wireline device.

27. A method as recited in claim 25, wherein receiving a call requesting said emergency response information from a communications device comprises receiving a call requesting said emergency response information from a wireless device.

28. A method as recited in claim 25 further comprising receiving feedback from said communications device.

29. A method as recited in claim 25 further comprising receiving an acknowledgement of receipt of said information.

30. A method as recited in claim 25 further comprising receiving confirmation that said information is accurate.

31. A method as recited in claim 25 further comprising receiving an indication that said information is not accurate.

32. A method as recited in claim 25 further comprising receiving a description of any inaccuracy of said information.

33. A method as recited in claim 25, wherein retrieving emergency response information associated with said communications device comprises retrieving emergency response information from an ALI database.

34. A method as recited in claim 25, wherein retrieving emergency response information associated with said communications device comprises retrieving emergency response information from an MPC.

35. A method as recited in claim 25, wherein retrieving emergency response information associated with said communications device comprises retrieving emergency response information from an SCP.

36. A method as recited in claim 25, wherein retrieving emergency response information associated with said communications device comprises retrieving emergency response information from a GMLC.

37. A method as recited in claim 25, wherein retrieving emergency response information associated with said communications device comprises retrieving emergency response information from an IPS.

38. A method as recited in claim 25, wherein retrieving emergency response information associated with said communications device comprises retrieving emergency response information from a positioning server.

39. A method as recited in claim 25, wherein retrieving emergency response information associated with said communications device comprises retrieving emergency response information from a position determining entity.

40. A method as recited in claim 25, wherein retrieving emergency response information associated with said communications device comprises retrieving emergency response information from a data provisioning method.

37. A method as recited in claim 25, further comprising a security subsystem configured to permit only authorized communications with said retrieval method.

38. A method as recited in claim 25, further comprising verifying that said communications device may access said information.

39. A method for a user to retrieve emergency response information comprising the steps of:
using a communications device to contact a retrieval system;
determining whether said user is an authorized user;
querying a source of emergency response information associated with said communications device; and
presenting said emergency response information to said communications device.

40. A method as recited in claim 39, further comprising the step of:
inviting verification of the accuracy of said emergency response information.

41. A method as recited in claim 40, further comprising the step of:
gathering a request for correction to said emergency response information.

42. A method as recited in claim 41, further comprising the step of:
providing said request to said source.
